(19) United States
(12) Patent Application Publication
(10) Pub. No.: US 2025/0125370 A1
(43) Pub. Date: Apr. 17, 2025

(54) HIGHLY GRAPHITIZED NITROGEN-DOPED POROUS CARBON STRUCTURE, LITHIUM-SULFUR BATTERY COMPRISING SAME, AND METHOD FOR MANUFACTURING SAME

(71) Applicant: Daegu Gyeongbuk Institute of Science and Technology, Daegu (KR)

(72) Inventors: Jong-Sung YU, Seoul (KR); Byong-June LEE, Busan (KR)

(73) Assignee: Daegu Gyeongbuk Institute of Science and Technology, Daegu (KR)

(21) Appl. No.: 18/834,149

(22) PCT Filed: Dec. 6, 2023
(86) PCT No.: PCT/KR2023/019957

§ 371 Date: Jul. 29, 2024

(30) Foreign Application Priority Data
Dec. 6, 2022 (KR) 10-2022-0168487

(51) Int. Cl. H01M 4/62; H01M 4/02; H01M 4/134; H01M 4/136; H01M 4/38; H01M 4/58; H01M 10/052

(52) U.S. Cl. CPC H01M 4/625; H01M 4/134; H01M 4/136; H01M 4/382; H01M 4/5815; H01M 10/052; H01M 2004/021; H01M 2004/027; H01M 2004/028

(57) ABSTRACT

The present invention relates to a carbon structure, which can stably support a high content of sulfur in pores and has excellent electrical conductivity properties, wherein the carbon structure is a polyhedron, of which the center on at least one side is concave, and is a highly graphitized nitrogen-doped porous carbon structure. Therefore, the stability of lithium-sulfur batteries can be improved by effectively suppressing a s shuttle phenomenon occurring during an electrochemical reaction of lithium-sulfur batteries containing, as a cathode active material, the carbon structure supporting sulfur as well as minimizing the volume change resulting from sulfur and reduced lithium sulfide.

### TECHNICAL FIELD

The present invention relates to a highly graphitized porous carbon structure doped with nitrogen, a lithium-sulfur battery including the same, and a method of preparing the same.

### BACKGROUND ART

Recently, a demand for energy storage devices is rapidly growing not only in portable electronic devices which are becoming smaller and lighter but also in the automobile industry due to environmental issues.

A lithium ion secondary battery (LIB) including a graphite-based electrode and a Li transition metal oxide has a disadvantage of low energy density and poor economic feasibility.

Thus, a lithium-sulfur battery using a sulfur-based material as a positive electrode active material and a lithium metal as a negative electrode active material is attracting attention as a next-generation secondary battery.

The theoretical energy density of the lithium-sulfur battery is 2,600 Wh/kg, which is about 5 times higher than the energy density of LIB (about 500 Wh/kg), and also, sulfur used as a positive electrode active material is naturally abundant, is environmentally friendly, has no toxicity, and has excellent economic feasibility.

However, the lithium-sulfur battery causes problems of reduced sulfur utilization efficiency, a rapid decrease in capacity, and deteriorated cycle properties due to chronic problems such as insulating properties of sulfur and products (Li₂S₂ and Li₂S) produced during a discharge process and irreversible loss of lithium polysulfide (Li₂Sₓ, 3≤x≤8) dissolved in an electrolyte solution, and has limits to its commercial use.

In addition, due to the low electrical conductivity properties of sulfur (5×10⁻³⁰ S/cm), a conductive host material capable of supporting sulfur is required. Since the host material for supporting sulfur should have a high specific surface area and pore volume, a porous carbon body having a pore size of less than 1 nm is conventionally used as the host material.

However, since the carbon body generally has non-polar properties, there are limits to suppressing a shuttle phenomenon in which lithium polysulfide dissolved in an electrolyte solution diffuses to a negative electrode due to the low affinity with polar lithium polysulfide.

Together with the problems, a conventional porous carbon body may include pores having a size of less than 1 nm to have a high specific surface area, but there is a problem in that an amount of sulfur supported within the pores is limited by the diameter of a sulfur molecule (0.68 nm), and after sulfur is reduced to lithium sulfide (Li₂S) by a reduction reaction of sulfur, destruction of an electrode due to volume expansion may be caused.

Thus, there is a need to develop a commercially available lithium-sulfur battery by stably supporting a large amount of sulfur within pores to minimize a change in electrode volume and effectively suppress the shuttle phenomenon.

### RELATED ART DOCUMENTS

### Patent Document

Korean Patent Laid-Open Publication No. 10-2020-0009401

### DISCLOSURE

### Technical Problem

An object of the present invention is to provide a carbon structure which may stably support a high content of sulfur within pores and has significantly improved electrical conductivity properties.

Another object of the present invention is to provide a composite in which sulfur is supported in the carbon structure described above, which may effectively suppress a shuttle phenomenon occurring during an electrochemical reaction of a lithium-sulfur battery.

Another object of the present invention is to provide a positive electrode for a lithium-sulfur battery including the composite described above as a positive electrode active material and a lithium-sulfur battery having significantly improved battery performance by including the positive electrode.

Still another object of the present invention is to provide a method of preparing the carbon structure described above which may improve performance of a lithium-sulfur battery.

### Technical Solution

In one general aspect, a highly graphitic porous carbon structure which is a polyhedron including at least one surface having a concave center and is doped with nitrogen is provided.

In the highly graphitic porous carbon structure according to an exemplary embodiment, the type of doped nitrogen may include a pyridinic nitrogen type, pyrrolic nitrogen type, and graphitic nitrogen type.

In the highly graphitic porous carbon structure according to an exemplary embodiment of the present invention, the doped nitrogen may include 90% or more of the pyridinic nitrogen type and the pyrrolic nitrogen type as a percentage based on the total content (at %) of nitrogen.

In the highly graphitic porous carbon structure according to an exemplary embodiment of the present invention, the carbon structure may include micropores, mesopores, and macropores.

In the highly graphitic porous carbon structure according to an exemplary embodiment of the present invention, the mesopores may be included at 50 vol % or more based on the total volume of pores included in the carbon structure. In the highly graphitic porous carbon structure according to an exemplary embodiment of the present invention, the carbon structure may have a BET surface area of 500 to 1000 m²/g.

In the highly graphitic porous carbon structure according to an exemplary embodiment of the present invention, the carbon structure may have a ratio (I_{G}/I_{D}) between a G band peak intensity (I_{G}) and a D band peak intensity (I_{D}) of 1 or more in a Raman spectrum.

In the highly graphitic porous carbon structure according to an exemplary embodiment of the present invention, the polyhedron may have a dodecahedron shape formed of a surface having a concave surface.

In another general aspect, a composite includes sulfur supported within pores of the highly graphitic porous carbon structure.

In the composite according to an exemplary embodiment of the present invention, the sulfur may be supported at a content of 1 to 15 mg/cm² within the pores of the carbon structure.

In the composite according to an exemplary embodiment of the present invention, the sulfur may include one or more selected from the group consisting of inorganic sulfur (S₈), metal sulfides, metal polysulfides, organic sulfur compounds, and polysulfides.

In the composite according to an exemplary embodiment of the present invention, the composite may have a dodecahedron shape formed of a surface having a concave center.

In another general aspect, a positive electrode for a lithium-sulfur battery includes the composite described as another general aspect as a positive electrode active material.

In the positive electrode for a lithium-sulfur battery according to an exemplary embodiment of the present invention, the positive electrode may include 1 to 15 mg/cm² of sulfur.

In another general aspect, a lithium-sulfur battery includes: a positive electrode including the composite described above as a positive electrode active material; a negative electrode including a lithium metal; a separator disposed between the positive electrode and the negative electrode; and an electrolyte.

In the lithium-sulfur battery according to an exemplary embodiment of the present invention, the positive electrode may include 1 to 15 mg/cm² of sulfur.

In the lithium-sulfur battery according to an exemplary embodiment of the present invention, a ratio between the electrolyte and sulfur (E/S ratio) may be 2 to 15 μL/mg.

In still another general aspect, a method of preparing a carbon structure is provided.

The method of preparing a carbon structure includes: a) metallothermically reducing a solid mixture in which a metal organic framework including nitrogen and a powdery metal reducing agent are mixed to prepare an intermediate structure; and b) acid etching a metal and a metal compound included in the intermediate structure to remove them.

In the method of preparing a carbon structure according to an exemplary embodiment of the present invention, the metal reducing agent may be one or more selected from the group consisting of magnesium (Mg), manganese (Mn), calcium (Ca), aluminum (Al), copper (Cu), zinc (Zn), tin (Sn), gallium (Ga), lithium (Li), sodium (Na), and potassium (K). In the method of preparing a carbon structure according to an exemplary embodiment of the present invention, the metal organic framework may be ZIF-8.

In the method of preparing a carbon structure according to an exemplary embodiment of the present invention, the metallothermic reduction may be performed at a temperature of 500 to 1000° C. under an inert gas atmosphere.

### Advantageous Effects

Since the carbon structure of the present invention is a highly graphitic porous carbon structure which is a polyhedron including at least one surface having a concave center and is doped with nitrogen, sulfur at a high content may be stably within supported pores, electrical conductivity properties may be significantly improved, and a shuttle phenomenon occurring during an electrochemical reaction of a lithium-sulfur battery including the sulfur-supported carbon structure as a positive electrode active material may be effectively suppressed.

In addition, a volume change resulting from sulfur and reduced lithium sulfide may be minimized to improve stability of a lithium-sulfur battery.

### DESCRIPTION OF DRAWINGS

In FIG. 1, (a), (b), (c), and (d) are drawings in which X-ray diffraction (XRD) patterns of the preparation example (ZIF-8) and before and after acid etching of Example 2 are compared, a drawing showing XRD patterns of Examples 1 to 4, a drawing showing Raman spectra of Examples 1 to 4, and a drawing in which XRD patterns of Comparative Example 1 and Example 2 are compared and shown, respectively.

In FIG. 2, (a) and (b) are drawings showing an N₂ absorption-desorption isotherm curve and Barrett-Joyner-Halenda (BJH) pore size distribution chart of the preparation example, respectively, (c) and (d) are drawings showing N₂ absorption-desorption isotherm curves and BJH size distribution charts of Examples 1 to 4, respectively, and (e) and (f) are drawings in which N₂ absorption-desorption isotherm curves and BJH pore size distribution charts of Comparative Example 1 and Example 2 are compared and shown, respectively.

FIG. 3 is a drawing showing scanning electron microscope (SEM) images of the preparation example, Comparative Example 1, and Examples 1 to 4.

In FIG. 4, (a) and (b) are drawings showing high-resolution transmission electron microscope (HRTEM) images of Example 2 and Comparative Example 1, respectively, and (c) and (d) are drawings showing high-angle annular dark-field-scanning transmission electron microscope (HAADF-STEM) images and element (C and N) mapping images of Example 2 and Comparative Example 1, respectively.

In FIG. 5, (a), (b), and (c) are drawings showing an XPS spectrum of Comparative Example 1, a high-resolution XPS spectrum of a C 1 s peak, and a high-resolution XPS spectrum of N 1 s peak, respectively, and (d), (e), and (f) are drawings showing an XPS spectrum of Example 2, a high-resolution XPS spectrum of a C 1 s peak, and a high-resolution XPS spectrum of a N 1 s peak, respectively.

FIG. 6 is a drawing showing and comparing the electrical conductivity properties of Comparative Example 1 and Example 2.

FIG. 7 is a schematic diagram which schematically shows a series of processes of synthesizing a composite which is prepared using the carbon structures of Comparative Example 1 and Example 2.

In FIG. 8, (a) and (b) are drawings showing XRD patterns and thermogravimetric analysis (TGA) results of the composites of Comparative Example 2 and Example 5, respectively.

FIGS. 9 and 10 are drawings showing SEM images and X-ray energy dispersive spectroscopy (EDS) element mapping images corresponding thereto of Comparative Example 2 and Example 5, respectively.

In FIG. 11, (a) and (b) are drawings showing CV profiles measured using cyclic voltammetry (CV) and charge and discharge curves depending on current density measured using galvanostatic charge-discharge for Example 6, respectively, and (c) and (d) are drawings showing CV profiles measured using cyclic voltammetry (CV) and charge and discharge curves depending on current density measured using galvanostatic charge-discharge for Comparative Example 3, respectively.

FIG. 12 is a drawing showing and comparing rate properties of Comparative Example 3 and Example 6.

In FIG. 13, (a) and (b) are a drawing showing cycle property results for 300 cycles under 0.2 C current density conditions, and a drawing showing cycle property results for 1000 cycles under 5 C current density conditions, for the batteries of Example 6 and Comparative Example 3, respectively.

In FIG. 14, (a) and (b) are drawings showing an EIS profile analyzed by electrochemical impedance spectroscopy (EIS) in a completely charged state and an EIS profile measured after charge and discharge of 100 cycles under 0.2 C current density conditions, respectively.

In FIG. 15, (a) is a drawing showing digital images of a lithium metal and a separator before battery assembly, a lithium metal and a separator disassembled from the battery of Comparative Example 3, and a lithium metal and a separator disassembled from the battery of Example 6 after a charge and discharge test, and (b), (c) and (d) are drawings showing SEM images of a lithium metal (negative electrode) before battery assembly, a lithium metal disassembled from the battery of Comparative Example 3, and the lithium metal disassembled from the battery of Example 6.

In FIG. 16, (a) and (b) are drawings showing SEM images of a positive electrode slurry including the composite of Comparative Example 2 as a positive electrode active material and a positive electrode slurry including the composite of Example 5 as a positive electrode active material before and after the charge and discharge test of 200 cycles under 1 C current density conditions, respectively.

In FIG. 17, (a) and (b) are drawings showing SEM images of cross sections of a positive electrode including the composite of Comparative Example 2 as a positive electrode active material and a positive electrode including the composite of Example 5 as a positive electrode active material before and after the charge and discharge test of 200 cycles under 1 C current density conditions, respectively.

In FIG. 18, (a) is a drawing showing cycle properties under 0.2 C current density conditions depending on a loading amount of sulfur for a battery to which an electrolyte solution was injected so that a ratio between the electrolyte solution and sulfur (E/S ratio) was 10 μL/mg, and (b) is a drawing showing a voltage profile depending on the E/S ratio of a battery having a sulfur loading amount of 8.3 mg/cm².

In FIG. 19, (a), (b), and (c) are drawings of cycle properties under 0.2 C current density conditions, rate properties when charge and discharge current densities were increased from 0.2 C to 0.5 C and then changed to 0.2 C again, and charge and discharge curves depending on current densities (0.1 C, 0.2 C, 0.3 C, and 0.5 C) measured using galvanostatic charge-discharge of Example 11, respectively.

### BEST MODE

Hereinafter, referring to the accompanying drawings, a highly graphitized porous carbon structure doped with nitrogen, a lithium-sulfur battery including the same, and a method of preparing the same will be described in detail.

The drawings to be provided below are provided by way of example so that the spirit of the present disclosure may be sufficiently transferred to a person skilled in the art. Therefore, the present invention is not limited to the drawings provided below but may be embodied in many different forms, and the drawings suggested below may be exaggerated in order to clarify the spirit of the present invention.

Technical terms and scientific terms used herein have the general meaning understood by those skilled in the art to which the present invention pertains, unless otherwise defined, and the description for the known function and configuration which may unnecessarily obscure the gist of the present invention will be omitted in the following description and the accompanying drawings.

In addition, the singular form used in the specification and claims appended thereto may be intended to include a plural form also, unless otherwise indicated in the context.

In the present specification and the appended claims, the terms such as “first” and “second” are not used in a limited meaning but are used for the purpose of distinguishing one constituent element from other constituent elements.

In the present specification and the appended claims, the terms such “comprise” or “have” mean that there is a characteristic or a constituent element described in the specification, and as long as it is not particularly limited, a possibility of adding one or more other characteristics or constituent elements is not excluded in advance.

Units used in the present specification and attached claims thereto without particular mention are based on weights, and as an example, a unit of % or ratio refers to a wt % or a weight ratio.

In the present specification and the appended claims, when a portion such as a membrane (layer), an area, and a constituent element is present on another portion, not only a case in which the portion is in contact with and directly on another portion but also a case in which other membranes (layers), other areas, other constitutional elements, and the like are interposed between the portions is included.

The carbon structure according to the present invention is a highly graphitic porous carbon structure which is a polyhedron including at least one surface having a concave center and is doped with nitrogen.

Thus, sulfur at a high content may be stably supported within pores of the carbon structure, and electrical conductivity properties are excellent.

In addition, a shuttle phenomenon occurring during an electrochemical reaction of a lithium-sulfur battery including the sulfur-supported carbon structure as a positive electrode active material may be effectively suppressed, and also, a volume change resulting from sulfur and reduced lithium sulfide may be minimized to improve stability of the lithium-sulfur battery.

As an example, the carbon structure may include micropores, mesopores, and macropores.

Herein, for each pore included in the carbon structure, pores having a diameter smaller than 2 nm are defined as micropores, pores having a diameter of 2 nm to 50 nm are defined as mesopores, and pores having a diameter of 50 nm or more are defined as macropores, according to IUPAC definition.

As an exemplary embodiment, mesopores may be included at 30 vol % or more, 40 vol % or more, 50 vol % or more, 60 vol % or more, or 70 vol % or more, and substantially 99% or less, more substantially 95% or less, based on the total volume of the pores included in the carbon structure.

Since the mesopores included in the carbon structure are included to satisfy the range described above, when the carbon structure is used as a conductive host for supporting sulfur, it is advantageous to support sulfur within the pores of the carbon structure.

As a specific example, the carbon structure may have a BET surface area of 200 m²/g or more, specifically 400 m²/g or more.

As an advantageous example, the carbon structure may have the BET surface area of 500 m²/g or more, specifically 500 to 1000 m²/g, more specifically 700 to 1000 m²/g, and still more specifically 800 to 1000 m²/g.

Since the carbon structure has the BET specific surface area in the range described above, when the carbon structure is used as a conductive host for supporting sulfur, a large amount of sulfur may be supported within a pore structure of the carbon structure, and since the large amount of sulfur is supported, when the carbon structure is applied to a lithium-sulfur battery, performance of the lithium-sulfur battery may be improved.

In an exemplary embodiment, the carbon structure may be a polyhedron including at least one surface having a concave center.

As an example, the polyhedron includes at least one surface having a concave center, and may be formed of 3 to 20, specifically 5 to 20, and more specifically 10 to 20 surfaces.

As a specific example, the polyhedron may have a dodecahedron shape formed of a surface having a concave center.

Since the shape of the carbon structure has a dodecahedron shape formed of a surface having a concave center together with the pore properties described above, when the carbon structure is used as a conductive host for supporting sulfur, a large amount of sulfur may be more stably supported in the pore structure of the carbon structure.

When a porous carbon body which has a high BET surface area but is formed of micropores of less than 1 nm is used as the conductive host for supporting sulfur as before, there is a limit to supporting sulfur within the pores, and most of the supported sulfur is positioned on the surface of a carbon body.

In general, in a lithium-sulfur battery including the sulfur-supported carbon body, that is, a carbon-sulfur composite as a positive electrode active material, an electrochemical reaction occurs by an oxidation reaction of lithium in a negative electrode (anode) and a reduction reaction of sulfur in a positive electrode (cathode), during a discharge reaction.

Herein, sulfur before discharge has a cyclic S₈ structure, and a S—S bond is broken during a reduction reaction (discharge) and the oxidation number of S is decreased, which causes an electrochemical reaction in which the cyclic S₈ is converted into lithium polysulfide (Li₂Sₓ, x=8, 6, 4, 2) having a linear structure by the reduction reaction, and finally, it is reduced to Li₂S which is a material insoluble in an electrolyte solution.

As known in the art, since sulfur and Li₂S have a large difference in density, when the supported sulfur is positioned mostly on the surface of the carbon body as before, the volume of the positive electrode is expanded during the charge and discharge process of the lithium-sulfur battery, which is fatal to safety to potentially destroy the positive electrode.

However, since the carbon structure according to an exemplary embodiment of the present invention has morphological properties of a polyhedron including at least one surface having a concave center, together with the pore properties described above, a large amount of sulfur is stably supported and positioned within the pores of the carbon structure, and thus, the volume expansion of the positive electrode may be effectively suppressed. That is, since the sulfur supported in the carbon structure is encapsulated and positioned in a porous network of the carbon structure, the volume change in the positive electrode may be minimized.

In an exemplary embodiment, the carbon structure is doped with nitrogen, and the type of doped nitrogen may include a pyridinic nitrogen type, pyrrolic nitrogen type, and graphitic nitrogen type.

Herein, the pyridinic nitrogen type refers to a nitrogen type in a pyridinic bond state, which is nitrogen present in the form of a compound which is single- or polysaturated in the form of a heterocyclic compound including 5 carbon atoms and the nitrogen atom, the pyrrolic nitrogen type refers to a nitrogen type in a pyrrolic bond state, which is nitrogen present in a heterocyclic compound including 4 carbon atoms and the nitrogen atom, and the graphitic nitrogen type refers to a nitrogen type in a graphitic bond state in which one carbon atoms is substituted with a nitrogen atom in a graphene lattice and then is bonded to the other 3 adjacent carbon atoms in a hexagonal ring.

As a specific example, doped nitrogen may include 90% or more, 91% or more, 92% or more, 93% or more, 94% or more, 95% or more, or 96% or more of the pyridinic nitrogen type and the pyrrolic nitrogen type as a percentage, and substantially 99.0% or less as a percentage, based on the total content (at %) of nitrogen.

Since the nitrogen doped into the carbon structure includes the pyridinic nitrogen type and the pyrrolic nitrogen type within the range described above, based on the total content (at %) of nitrogen, the shuttle phenomenon of the polar lithium polysulfide (Li₂Sₓ, 3≤x≤8) may be effectively suppressed.

Specifically, a common carbon body like before is non-polar, and due to its low affinity with polar lithium polysulfide produced by an electrochemical reaction in a lithium-sulfur battery, the polar lithium polysulfide soluble in an electrolyte solution undergoes a shuttle phenomenon in which the lithium polysulfide diffuses in a negative electrode direction by a difference in concentration.

Herein, the polar lithium polysulfide which is eluted from a positive electrode and diffuses in a negative electrode direction by the shuttle phenomenon is lost out of a positive electrode reaction area and does not participate in the charge and discharge reaction of the lithium-sulfur battery anymore, and eventually causes deterioration of capacity properties and cycle properties of the lithium-sulfur battery.

However, since the carbon structure according to an exemplary embodiment of the present invention is doped with nitrogen including the pyridinic nitrogen type and the pyrrolic nitrogen type in the range described above based on the total content (at %) of nitrogen, unlike the conventional carbon body, it may have high affinity for polar lithium polysulfide, whereby the polar lithium polysulfide is adsorbed in/on the pores and/or the surface of the carbon structure and thus, elution of the polar lithium polysulfide into an electrolyte solution may be effectively suppressed. As a specific example, the pyrrolic nitrogen type included in the doped nitrogen may be included at 30% or more, specifically 40% or more, and more specifically 50% or more as a percentage. Since the pyrrolic nitrogen type satisfies the range described above and is included in the doped nitrogen, when the carbon structure is used as a conductive host for supporting sulfur, elution of the polar lithium polysulfide into an electrolyte solution is more effectively suppressed, thereby improving the capacity properties and the cycle properties of the lithium-sulfur battery.

As an example, the carbon structure may be doped with 0.5 to 15 at %, specifically 1 to 12 at %, and more specifically 3 to 10 at % of nitrogen.

Since the content of nitrogen doped into the carbon structure satisfies the range described above, the shuttle phenomenon of the polar lithium polysulfide may be effectively suppressed and also the electrical conductivity properties of the carbon structure may be improved.

As an example, the carbon structure may be a highly graphitic carbon structure.

Herein, “highly graphitic” means that similarity with a crystal structure of graphite is very high, and may be defined as an intensity of a specific band peak and/or a ratio of an intensity in a Raman spectrum.

As an exemplary embodiment, the carbon structure may have a ratio (I_{G}/I_{D}) between an intensity (I_{G}) of a G band peak and an intensity (I_{D}) of a D band peak of 0.95 or more, 1 or more, 1.05 or more, or 1.1 or more, and the upper limit is not limited, but may be substantially 1.5 or less in the Raman spectrum.

Herein, the D band peak of the Raman spectrum refers to a disordered C-sp³ bond, and the G band peak refers to a graphite structure of a C-sp² covalent bond. That is, as the G band peak intensity of a graphite structure compared with the disordered D band peak is higher, it may be referred to as being highly graphitic. The highly graphitic carbon support may have excellent electrical properties similar to graphite, and electrons may rapidly move by the effect, which may be advantageous for improving battery performance.

The present invention provides a composite including sulfur supported within pores of the highly graphitic porous carbon described above as another embodiment.

Herein, as a method for supporting sulfur on the carbon structure, any method known in the art may be used and performed without limitation.

As an example, sulfur may be supported within the pores of the highly graphitic porous carbon structure described above using a melting diffusion method, but is not limited thereto.

In addition, sulfur supported by the melting diffusion method may be positioned within the pore structure of the carbon structure, and also, some sulfur may be present in the form of being coated on the surface of the carbon structure, of course.

As an exemplary embodiment, sulfur may be supported at a content of 1 to 30 mg/cm², specifically 1 to 15 mg/cm², and more specifically 2 to 10 mg/cm² within the pores of the carbon structure.

As a specific example, the polyhedron may have a dodecahedron shape formed of a surface having a concave center.

As described above, sulfur is stably supported within the pores of the carbon structure by the pore properties and the morphological properties of the carbon structure, and though it is supported at a high content, the shape of the composite may be maintained to have substantially the same shape as that of the carbon structure.

As such, since the composite in which sulfur is supported in the carbon structure has a dodecahedron shape formed of a surface having a concave center, the volume change of the composite which may be shown by the electrochemical reaction may be minimized, and the shuttle phenomenon of the polar lithium polysulfide may be effectively suppressed.

As an example, sulfur supported in the carbon structure may include one or more selected from the group consisting of inorganic sulfur (S₈), metal sulfides, metal polysulfides, organic sulfur compounds, and polysulfides.

An example of the metal sulfide may be a lithium polysulfide Li₂Sn (1≤n≤8), and the metal polysulfide may be MSₙ (M=Ni, Co, Cu, Fe, Mo, Ti, Nb, 1≤n≤4), and an example of the organic sulfur compound may be an organic disulfide compound or a carbon sulfide compound, but is not limited thereto.

In addition, the present invention provides a positive electrode for a lithium-sulfur battery including the composite described above, that is, a sulfur-supported carbon structure as a positive electrode active material.

Herein, the positive electrode may be formed by applying a positive electrode slurry including the composite as a positive electrode active material on a current collector and drying it, and as a method of applying and drying the positive electrode slurry, any method known in the art may be used without limitation.

As an example, a current collector included in the positive electrode may be a metal having excellent conductivity, and as a non-limiting example, may be selected from aluminum, nickel, copper, stainless steel, and the like, but is not limited thereto.

As a specific example, the positive electrode slurry may further include a conductive material and a binder. The conductive material included in the positive electrode slurry may include any one or more selected from a graphite-based material, a carbon-based material, and a conductive polymer.

The graphite-based material may be any one or two or more selected from natural graphite and artificial graphite. The carbon-based material may be one or two or more selected from ketjen black, denka black, acetylene black, carbon black, and the like. In addition, the conductive polymer may be one or two or more selected from polyaniline-based polymers, polythiophene-based polymers, polyacetylene-based polymers, and polypyrrole-based polymers, and the like.

The binder included in the positive electrode slurry is for physically binding the composite and the conductive material or attaching them to a current collector, and may be a polymer binder.

The polymer binder may include, as an example, one or two or more selected from poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a copolymer of polyhexafluoropropylene and polyvinylidene fluoride, poly(ethyl acrylate), polytetrafloroethylene, and derivatives, blends, and copolymers, thereof, but is not limited thereto.

As an exemplary embodiment, a weight ratio of the conductive material: the composite included in the positive electrode for a lithium-sulfur battery may be 1:1 to 15, specifically 1:5 to 10.

In addition, the present invention provides a lithium-sulfur battery including: a positive electrode including the composite described above as a positive electrode active material; a negative electrode including a lithium metal; a separator disposed between the positive electrode and the negative electrode; and an electrolyte.

Herein, the positive electrode including the composite as a positive electrode active material is as described above or similar to the description, and the detailed description thereof will be omitted.

As a specific example, the positive electrode may include 1 to 15 mg/cm², specifically 2 to 12 mg/cm², and more specifically 5 to 10 mg/cm² of sulfur.

As the loading amount of sulfur included in the positive electrode is increased, the initial specific capacity properties of the lithium-sulfur battery may be improved, but when the positive electrode includes 15 mg/cm² or more of sulfur, cycle stability may be rapidly deteriorated and positive electrode breakage by volume expansion of the positive electrode may be caused, and thus, it is advantageous for the positive electrode to include sulfur in the range described above.

The separator is a physical separator having a function of physically separating a positive electrode and a negative electrode, and may be usually used without particular limitation as long as it is used as the separator in the lithium-sulfur battery field.

Specifically, a separator having excellent moisture containing ability to the electrolyte and low resistance against lithium ion mobility s preferred. More specifically, the separator may be a porous polymer separator, may be exemplified as an olefin-based homopolymer or copolymer, an olefin-acrylate copolymer, and the like, and may be used as a single layer or composite layer form, but the present invention is not limited thereto.

An electrolyte is a medium to dissociate lithium used as a negative electrode or negative electrode active material into ions and move the ions from a negative electrode to a positive electrode to allow current flow, may have a liquid electrolyte or a solid electrolyte form, and as an advantageous example, may be a liquid electrolyte.

The liquid electrolyte may include a non-aqueous organic solvent and a lithium salt.

The non-aqueous organic solvent may be polar solvents such as sulfoxide-based compounds, sulfate-based compounds, sulfite-based compounds, lactone-based compounds, ketone-based compounds, ester-based compounds, carbonate-based compounds, and ether-based compounds, and as a non-limiting example, may be ethylene carbonate, tetrahydrofuran, 1,4-dioxane, 1,3-dioxolane, dimethyl carbonate, ethylene glycol sulfite, 3-methyl-2-oxazolidone, triethylene glycol monomethyl ether, N-methylpyrrolidone, 1,2-dimethoxyethane, dimethyl acetamide, or ethylene glycol diacetate, but is not limited thereto.

In addition, the lithium salt included in the liquid electrolyte may be any one or more selected from the group consisting of LiF, LiBF₄, LiPF₆, lithium bis(trifluoromethanesulfonyl)imide (LiTFSI), LiCF₃SO₃, Li(CF₃SO₃)₂N, LiC₄F₉SO₃, LiSbF₆, and LiAsF₆, but is not limited thereto.

Herein, a molar concentration of the lithium salt in the electrolyte may be 0.1 to 2 M, specifically 0.5 to 1.5 M.

As an exemplary embodiment, a ratio between the electrolyte and sulfur (E/S ratio) may be 2 to 15 μL/mg, specifically 2 to 10 μL/mg, and more specifically 2 to 5 μL/mg.

As such, since the positive electrode included in the lithium-sulfur battery according to an exemplary embodiment of the present invention includes sulfur having the pore properties and morphological properties described above and includes a composite stably supported within the pores of the carbon structure having excellent electrical conductivity as a positive electrode active material, it may show excellent battery performance even under lean electrolyte conditions.

Herein, the lean electrolyte conditions may refer to conditions of the ratio of the electrolyte and sulfur of less than 10 μL/mg, specifically less than 7 μL/mg, and more specifically less than 5 μL/mg.

The present invention provides a method of preparing the carbon structure described above.

The method of preparing a carbon structure includes: a) metallothermically reducing a solid mixture in which a metal organic framework including nitrogen and a powdery metal reducing agent are mixed to prepare an intermediate structure; and b) acid etching a metal and a metal compound included in the intermediate structure to remove them.

As such, the carbon structure which is the host material of sulfur applicable to the lithium-sulfur battery may be prepared by a simple process of a metallothermic reduction process and an acid etching process, and also, the performance of the lithium-sulfur battery including the prepared carbon structure may be improved.

As an exemplary embodiment, the intermediate structure of step a) may be prepared by metallothermically reducing a solid mixture in which the metal organic framework: the metal reducing agent are mixed at a weight ratio of 1:0.1 to 2, specifically 1:0.5 to 1.5.

Herein, the solid mixture may be mixed by mechanically pulverizing the metal organic framework and the metal reducing agent mixed at the weight ratio described above, and as an example, may be mixed by a method of ball milling, roller milling, impact crushing, or hammer milling, but the present invention is not limited thereto.

As a specific example, the metal organic framework included in the solid mixture includes nitrogen, and may be any one selected from metal organic framework (MOF)-867 and zeolitic imidazolate framework (ZIF)-8, ZIF-7, ZIF-11, ZIF-12, ZIF-22, ZIF-67, and ZIF-90, and as an advantageous example, may be ZIF-8.

As known in the art, nitrogen included in ZIF-8 which is the metal organic framework including micropores of less than 1 nm may be extracted by the metal reducing agent and form a metal nitride with a first metal included in the metal reducing agent. By removing the formed metal nitride by the acid etching process described later, a hierarchical pore structure including mesopores and macropores having new sizes as well as micropores included in the metal organic framework may be formed in the carbon structure.

As an exemplary embodiment, the metal reducing agent may be one or more selected from the group consisting of magnesium (Mg), manganese (Mn), calcium (Ca), aluminum (Al), copper (Cu), zinc (Zn), tin (Sn), gallium (Ga), lithium (Li), sodium (Na), and calcium (K), and as an advantageous example, may be magnesium (Mg).

The process of preparing the intermediate structure, that is, the metallothermic reduction process, may change the pore properties of the carbon structure by the metal nitride formed by a reaction between nitrogen included in the metal organic framework and a first metal included in the metal reducing agent, as described above, and also, may affect the crystallinity and the morphological properties of the carbon structure.

Specifically, as a temperature of the metallothermic reduction process performed for preparing the intermediate structure from the solid mixture is higher, the crystallinity of the carbon structure may be improved, but the morphological properties of the metal organic framework as a base collapse to make it difficult to implement the pore properties of the carbon structure to be desired.

In addition, when a temperature of the metallothermic reduction process is higher than 1000° C., nitrogen included in the metal organic framework is lost so that formation of a metal nitride is limited, and finally, the content of nitrogen doped into the finally prepared carbon structure may be decreased.

As described above, in order to apply the carbon structure as the host material of sulfur, the carbon structure shows excellent electrical conductivity properties by improved crystallinity, and a pores structure to support a high content of sulfur within the pores and to effectively suppress a volume change should be provided, and in order to effectively suppress the shuttle phenomenon of a polar lithium polysulfide, a certain type of nitrogen should be doped.

In this respect, the carbon structure obtained by acid etching the intermediate structure prepared by thermally reducing the solid mixture with metal using magnesium (Mg) having a relatively low melting point and excellent reducing power as the metal reducing agent satisfies the properties described above and is advantageous for being applied as the host material of sulfur.

Herein, since nitrogen included in the metal organic framework as a base is extracted in the process of forming the intermediate structure to form a metal nitride, the shape of the base may be partially transformed.

Specifically, when the metal organic framework is ZIF-8, the metal organic framework has a dodecahedron shape formed of flat surfaces, and the intermediate structure prepared by the metallothermic reduction process may have a dodecahedron shape which is formed of a surface having a concave center. When the carbon structure finally obtained by the morphological properties is applied as the host material of sulfur, sulfur may be stably supported within the pores of the carbon structure.

As an exemplary embodiment, the metallothermic reduction may be performed at a temperature of 500 to 1000° C., favorably 600 to 900° C., and more favorably 700 to 800° C. under an inert gas atmosphere.

Herein, the metallothermic reduction may be performed for 2 to 10 hours, specifically 4 to 6 hours by supplying helium, argon, neon, nitrogen, or ammonia gas for the inert gas atmosphere.

Since the metallothermic reduction process is performed under the conditions described above, the carbon structure obtained by the acid etching described later has the properties described above and is advantageous for being applied as the host material of sulfur.

The intermediate structure may include a metal including a second metal derived from the metal organic framework, a first metal derived from the metal reducing agent, and a metal compound which is the compound thereof, and the metal and the metal compound included in the intermediate structure may be removed by the acid etching process.

As a specific example, the acid etching may be performed using an acid solution including one or more acids selected from hydrochloric acid, sulfuric acid, phosphoric acid, and nitric acid, in which the concentration of the acid solution may be 0.1 to 5 M, specifically 0.5 to 3 M.

After adding the intermediate structure to the acid solution described above for completely removing the metal and the metal compound included in the intermediate structure, stirring is performed for 2 to 10 hours, specifically 4 to 8 hours to perform the acid etching, and then the recovered product may be filtered with deionized water and the like and dried under vacuum to obtain the carbon structure.

Hereinafter, the highly graphitic porous carbon structure doped with nitrogen according to the present invention, the lithium-sulfur battery including the same, and a method of preparing the same will be described in more detail by the examples. However, the following examples are only a reference for describing the present disclosure in detail, and the present disclosure is not limited thereto and may be implemented in various forms.

In addition, unless otherwise defined, all technical terms and scientific terms have the same meanings as those commonly understood by a person skilled in the art to which the present disclosure pertains. The terms used herein are only for effectively describing a certain exemplary embodiment, and are not intended to limit the present disclosure.

### (Preparation Example) Preparation of ZIF-8

To a mixed solution in which a first solution of 22.7 g of 2-methylimidazole dissolved in 80 mL of methanol and a second solution of 4.17 g of zinc nitrate (Zn(NO₃)₂·6H₂O) dissolved in 20 mL of methanol were mixed, 10 mL of deionized water was further added, and then stirring was performed for 1 hour.

After the stirring, the reactant was aged for 24 hours, and then centrifuged to obtain a product. The obtained product was washed with ethanol, and dried for 6 hours under vacuum conditions at a temperature of 60° C. to prepare a zeolite imidazolate framework (ZIF-8).

### Example 1

1 g of ZIF-8 prepared above was mechanically ground with 1 g of magnesium (Mg) powder and then mixed to prepare a solid mixture.

Subsequently, the mixture was formed into an intermediate structure using magnesiothermic reduction at a temperature of 650° C. At this time, the magnesiothermic reduction process was performed for 5 hours under an argon gas atmosphere, and a heating rate was fixed to 5° C./min.

Thereafter, a residue containing metal included in the intermediate structure was removed by acid etching using a 2.0 M hydrochloric acid (HCL) solution, and then washing with deionized water and vacuum drying at a temperature of 60° C. for 6 hours were performed to prepare a carbon structure, and the prepared carbon structure was named HGNPC-650.

### Example 2

A carbon structure was prepared in the same manner as in Example 1, except that the magnesiothermic reduction process was performed at a temperature of 750° C., and was named HGNPC-750.

### Example 3

A carbon structure was prepared in the same manner as in Example 1, except that the magnesiothermic reduction process was performed at a temperature of 850° C., and was named HGNPC-850.

### Example 4

A carbon structure was prepared in the same manner as in Example 1, except that the magnesiothermic reduction process was performed at a temperature of 950° C., and was named HGNPC-950.

### Comparative Example 1

A carbon structure was prepared in the same manner as in Example 1, except that the magnesiothermic reduction process was not performed and ZIF-8 was carbonized at a temperature of 750° C. This was named NPC-750.

### (Experimental Example 1) Analysis and Comparison of Carbon Structure

In FIG. 1, (a), (b), (c), and (d) are drawings in which X-ray diffraction (XRD) patterns of the preparation example (ZIF-8) and before and after acid etching of Example 2 are compared, a drawing showing XRD patterns of Examples 1 to 4, a drawing showing Raman spectra of Examples 1 to 4, and a drawing in which XRD patterns of Comparative Example 1 and Example 2 are compared and shown, respectively.

Referring to (a) of FIG. 1, it was observed that diffraction peaks corresponding to magnesium nitride (Mg₃N₂, JCPDS No. 01-073-1070) existed in diffraction angles (20) at 18.4°, 21.6°, 30.8°, 33.5°, 35.8°, and 51.7° together with the diffraction peaks of graphitic carbon in the XRD pattern of Example 2 before the etching. It was found therefrom that nitrogen and magnesium in the intermediate structure prepared by the magnesiothermic reduction reacted to produce magnesium nitride. In the XRD pattern of Example 2 after the acid etching, it was confirmed that diffraction peaks existed at diffraction angles of 26.2° and 43° corresponding to (002) and (100) planes of graphite, and a diffraction peak of broad amorphous carbon existed at a diffraction angle of 25° C. It was found that the residual metal and the metal compound including magnesium nitride included in the intermediate structure were removed by the acid etching.

In addition, as shown in the XRD diffraction pattern of (b) 1, was of FIG. it confirmed that as the magnesiothermic reduction process temperature was increased, the intensity of the diffraction peaks corresponding to (002) and (100) planes of graphite was further increased and the diffraction peak of broad amorphous carbon was decreased, so that a graphitization degree was improved.

The properties were identically observed also in the Raman spectrum of (c) of FIG. 1.

Specifically, when a ratio (I_{G}/I_{D}) between a G band peak intensity (I_{G}) positioned at the Raman shift at 1577 cm⁻¹ showing a graphitic structure of a C-sp² covalent bond and a D band peak intensity (I_{D}) at the Raman shift at 1320 cm⁻¹ showing a disordered C-sp³ bond was compared, it was found that the I_{G}/I_{D} value was increased as the magnesiothermic reduction temperature was increased.

In addition, in Examples 3 and 4 prepared at the magnesiothermic reduction process temperature at 850° C. or higher, it was observed that a 2D peak which is observed only in highly graphitic carbon existed in the Raman shift near 2700 cm⁻¹.

However, it was confirmed that the I_{G}/I_{D} value of Comparative Example 1 was 0.91, which was even a lower graphitization degree than the value of Example 1 (0.92) which was prepared at the lowest magnesiothermic reduction process temperature.

As seen in the results of XRD diffraction pattern and Raman spectrum analyses, it was confirmed that the carbon structures of Examples 1 to 4 had a highly graphitic structure. However, as shown in (d) of FIG. 1, only a diffraction peak corresponding to amorphous carbon existed in Comparative Example 1.

Further, the pore properties of each carbon structure were compared and analyzed.

In FIG. 2, (a) and (b) are drawings showing an N₂ absorption-desorption isotherm curve and Barrett-Joyner-Halenda (BJH) pore size distribution chart of the preparation example, respectively, (c) and (d) are drawings showing N₂ absorption-desorption isotherm curves and BJH pore size distribution charts of Examples 1 to 4, respectively, and (e) and (f) are drawings in which N₂ absorption-desorption isotherm curves and BJH pore size distribution charts of Comparative Example 1 and Example 2 are compared and shown, respectively.

Referring to (a) of FIG. 2, it was confirmed that ZIF-8 which was the preparation example included mainly micropores and its isothermal curve was shown to be a typical type I, and had a pore size of 1 nm or less as shown in the BJH pore size distribution chart of (b) of FIG. 2.

However, in (c) and (d) of FIG. 2, it was found that Examples 1 to 4 showed isothermal curves of type IV together with a H4 hysteresis loop, and likewise, included micropores, mesopores, and macropores in the BJH pore size distribution chart.

In (e) and (f) of FIG. 2 in which the pore properties of Comparative Example 1 and Example 2 are compared and shown, Comparative Example 1 showed a type I isothermal curve like the preparation example, and for the pores also, included only micropores of less than 2 nm.

It was found therefrom that in the carbon structures of Examples 1 to 4 prepared by the acid etching process after preparing an intermediate structure using the magnesiothermic reduction from ZIF-8, unlike Comparative Example 1, mesopores and macropores were newly formed by removing the residual metal and the metal compound including magnesium nitride in the acid etching process, as well as the micropores.

Further, the BET surface area properties and the volume of each pore calculated using the Brunauer-Emmett-Teller (BET) method from the pore analysis results described above are summarized in the following Table 1.

TABLE 1

| | BET | Micropore | Mesopore | Total pore |
|---|---|---|---|---|
| | surface area | volume | volume | volume |
| Sample | (m² · g⁻¹) | (cm³ · g⁻¹) | (cm³ · g⁻¹) | (cm³ · g⁻¹) |
| Preparation | 1841 | 0.63 | 0.07 | 0.70 |
| Example | | | | |
| (ZIF-8) | | | | |
| Comparative | 764 | 0.29 | 0.1 | 0.39 |
| Example 1 | | | | |
| (NPC-750) | | | | |
| Example 1 | 724 | 0.17 | 0.5 | 0.67 |
| (HGNPC-650) | | | | |
| Example 2 | 815 | 0.14 | 0.63 | 0.77 |
| (HGNPC-750) | | | | |
| Example 3 | 398 | 0.08 | 0.5 | 0.58 |
| (HGNPC-850) | | | | |
| Example 4 | 301 | 0.05 | 0.49 | 0.54 |
| (HGNPC-950) | | | | |

As shown in FIG. 1, it was found that in the preparation example and Comparative Example 1, 74.4 vol % or more of the total pores were formed of micropores, which was identical to the pore properties based on the N₂ adsorption/desorption isothermal curve and the BJH pore size distribution chart described above.

In addition, it was observed that the BET surface area of Comparative Example 1 which had very similar pore properties to the preparation example was rapidly decreased as compared with the preparation example, and it is understood that a sealing phenomenon occurred in a carbonization process and about 60 vol % of pores included in the preparation example disappeared.

However, it was found that the carbon structures of Examples 1 to 4 which were prepared by the acid etching process after preparing the intermediate structure using the magnesiothermic reduction included more than 74.6 vol % of mesopores of the total pores.

In particular, it was confirmed that Example 2 included 80 vol % of mesopores of the total pores, but showed better BET surface area properties than Comparative Example 1.

Furthermore, morphological properties of each carbon structure were compared and analyzed.

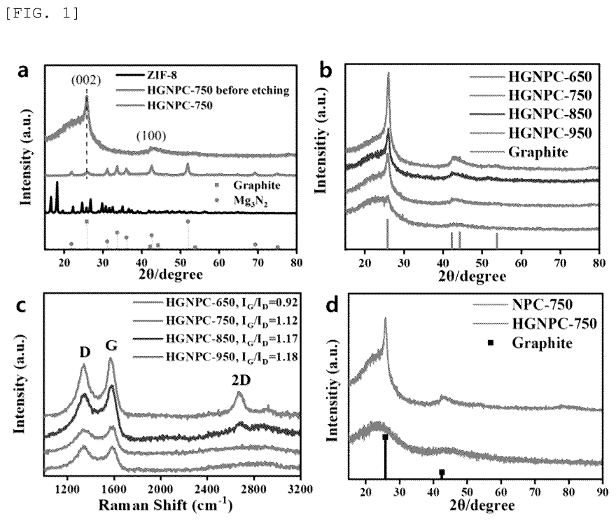

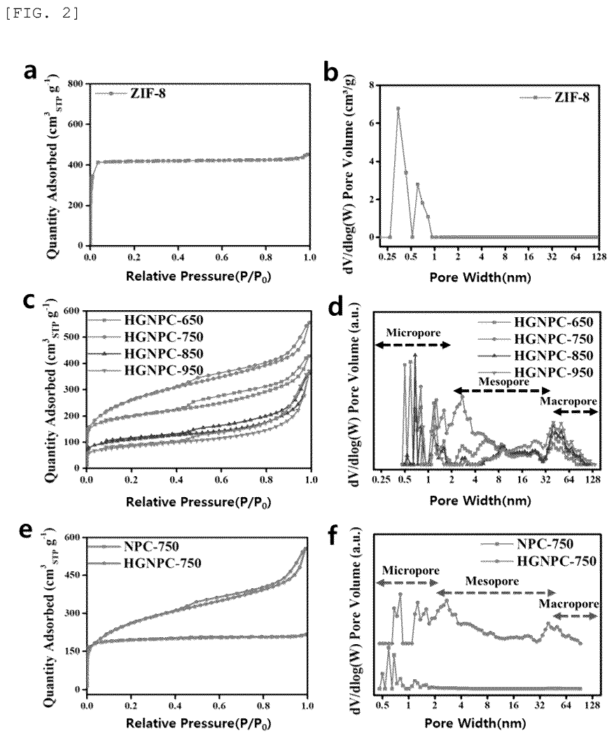

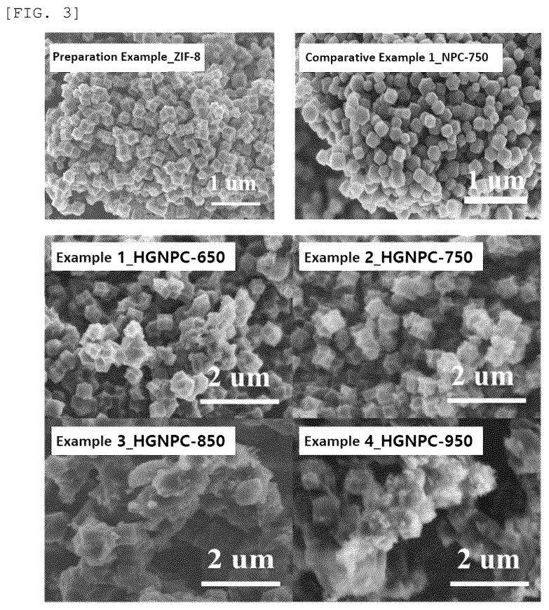

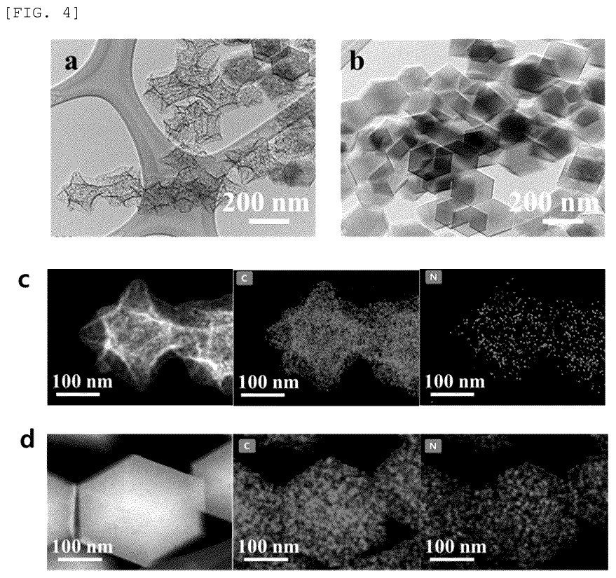

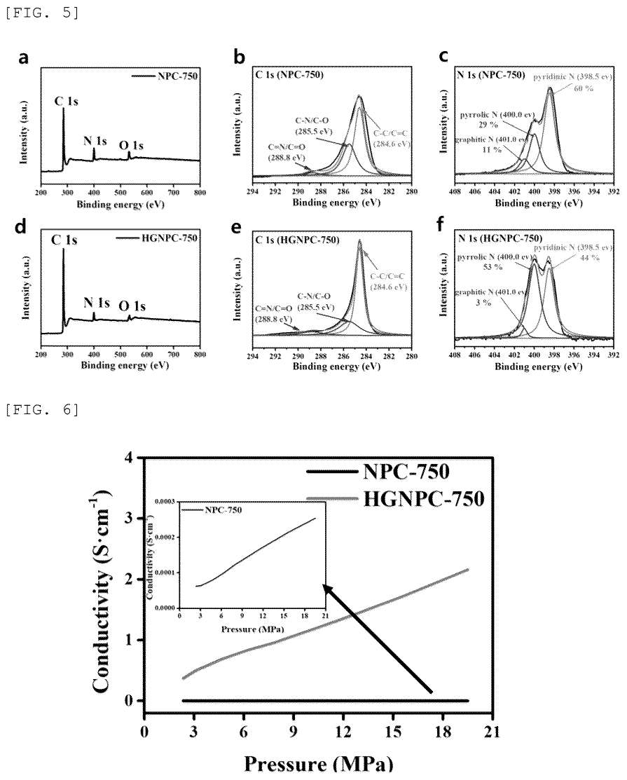

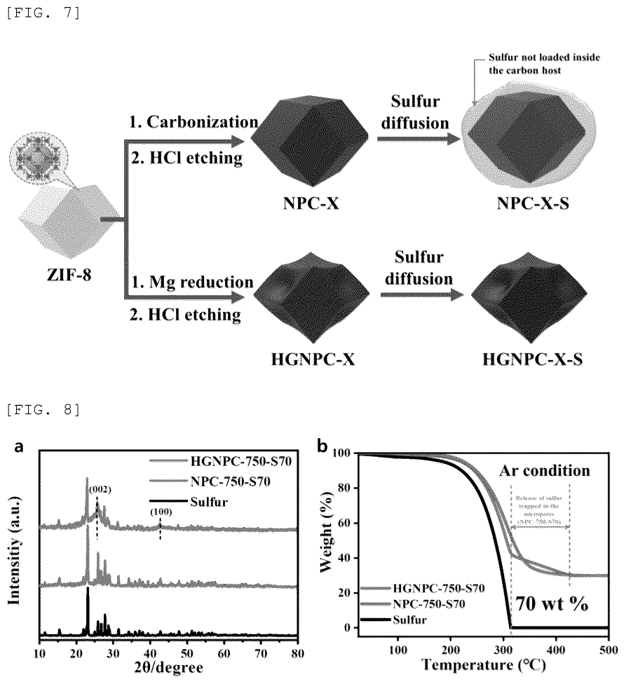

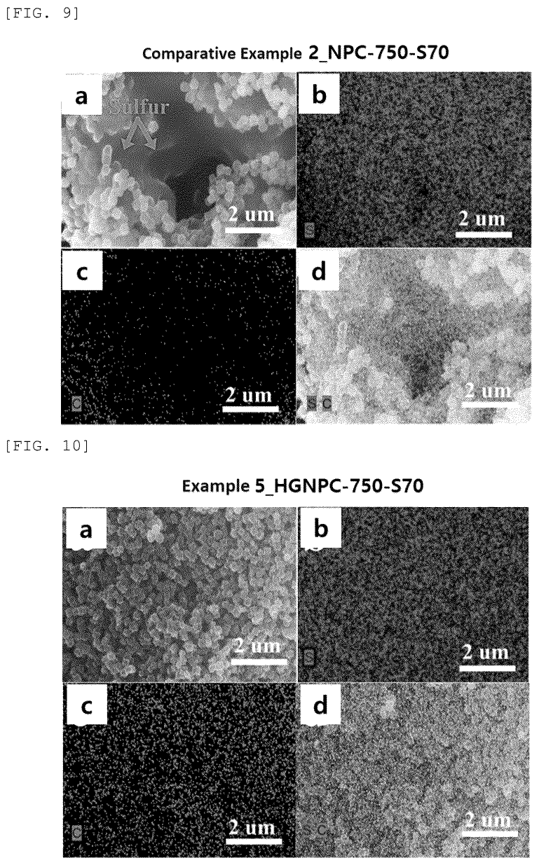

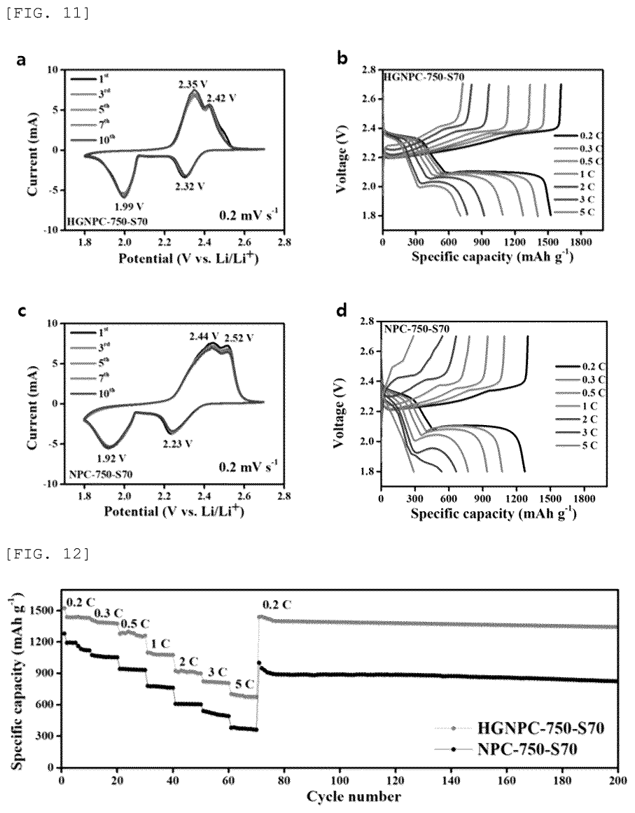

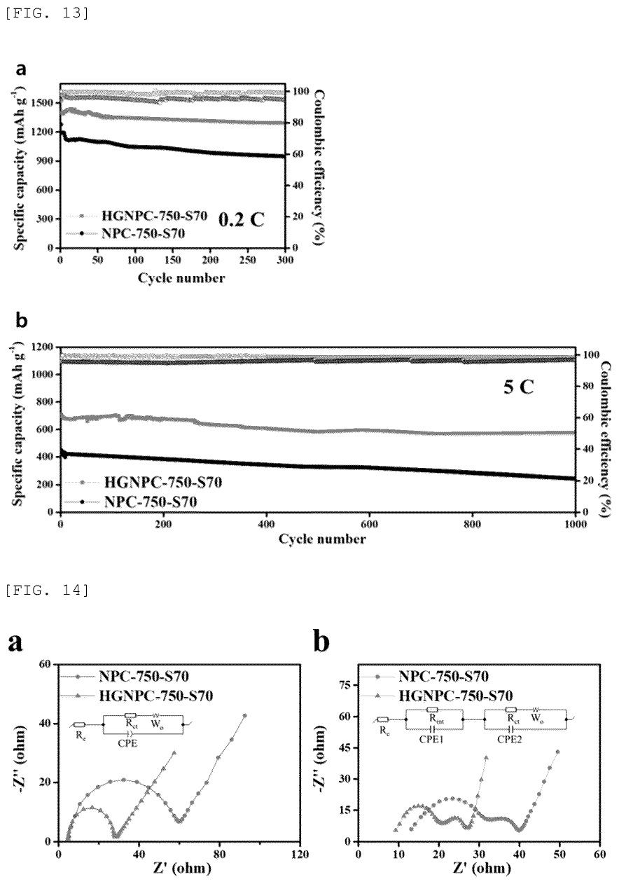

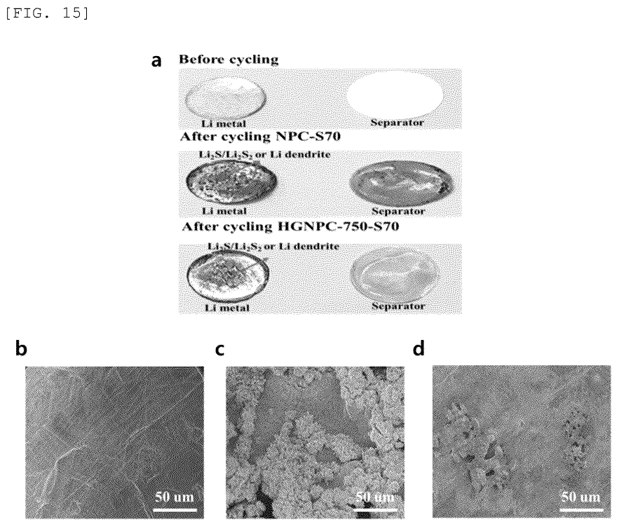

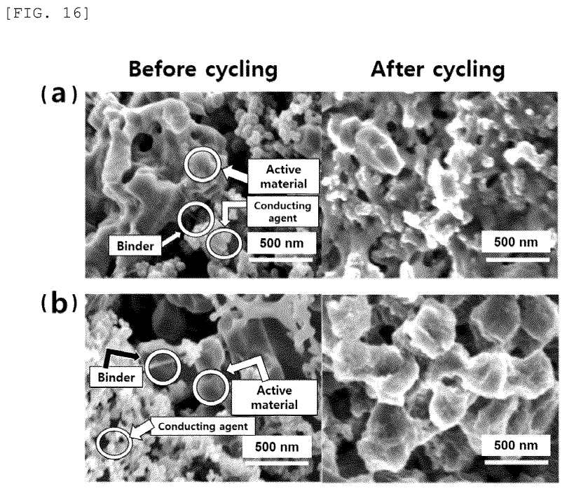

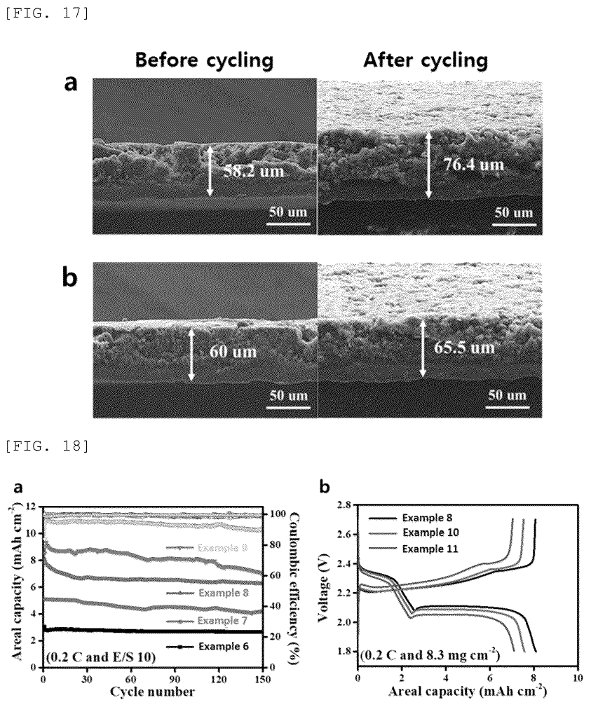

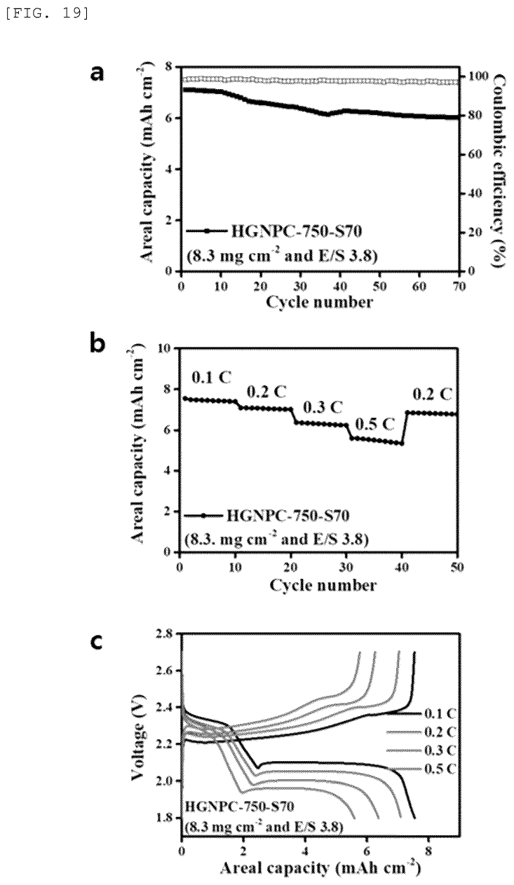

FIG. 3 is a drawing showing scanning electron microscope (SEM) images of the preparation example, Comparative Example 1, and Examples 1 to 4.

In FIG. 3, it was observed that ZIF-8 particles of the preparation example had a rhombic dodecahedron shape having a size of 250 nm and the carbon structure of Comparative Example 1 also had a substantially similar shape to ZIF-8.

However, it was found that the carbon structures of Examples 1 and 2 maintained the dodecahedron shape, but the size of the carbon structures was reduced to 200 nm with the structural deformation, and in the carbon structures of Examples 3 and 4, the dodecahedron shape of ZIF-8 as a base collapsed.

In order to more thoroughly review the morphological changes, the carbon structures of Comparative Example 1 and Example 2 were further analyzed.

In FIG. 4, (a) and (b) are drawings showing high-resolution transmission electron microscope (HRTEM) images of Example 2 and Comparative Example 1, respectively, and (c) and (d) are drawings showing high-angle annular dark-field-scanning transmission electron microscope (HAADF-STEM) images and element mapping images of Example 2 and Comparative Example 1, respectively. At this time, the element mapping images were obtained using energy dispersive X-ray (EDX) spectroscopy.

Referring to the HRTEM images of (a) and (b) of FIG. 4, it was observed that the carbon structure of Comparative Example 1 had a polyhedron structure having a flat surface with a dense core and showed substantially the same morphological properties as ZIF-8 as a base, but the carbon structure of Example 2 had a curved structure having a rough surface by pores with a hollow core structure.

That is, it was found that the carbon structure of Example 2 showed the morphological properties in which the center of the surface forming the polyhedron had a concave shape. This is because nitrogen was extracted by magnesium reduction from ZIF-8 as a base in the step of forming the intermediate structure, and Mg₃N₂ was formed.

As shown in (c) and (d) of FIG. 4, in both Comparative Example 1 and Example 2, it was confirmed that carbon and nitrogen were uniformly distributed, but in Example 2, nitrogen was consumed by reduction of magnesium which contributed to morphological change and formation of mesopores and macropores in the carbon structure and a nitrogen content was decreased, as compared with Comparative Example 1.

In order to analyze the chemical state of the surfaces of the prepared carbon structures of Comparative Example 1 and Example 2, X-ray photoelectron spectroscopy was performed using an XPS system (ESCALAB 250 XPS system).

In FIG. 5, (a), (b), and (c) are drawings showing an XPS spectrum of Comparative Example 1, a high-resolution XPS spectrum of a C 1 s peak, and a high-resolution XPS spectrum of N 1 s peak, respectively, and (d), (e), and (f) are drawings showing an XPS spectrum of Example 2, a high-resolution XPS spectrum of a C 1 s peak, and a high-resolution XPS spectrum of a N 1 s peak, respectively.

The content of nitrogen included in Comparative Example 1 and Example 2 calculated from the XPS spectrum of (a) and (d) of FIG. 5 was confirmed to be 9.15 at % and 6.73 at %, respectively. It was found that the results were consistent with the result in which the nitrogen content included in the carbon structure of Example 2 was decreased as compared with Comparative Example 1 from the element mapping images described above.

In the high resolution XPS spectrum of a C 1 s peak of (b) and (e) of FIG. 5, it was found that peaks corresponding to C—C(C═C), C—N(C—O), and C═N (C═O) bonds were positioned at binding energies of 284.6 eV, 285.5 eV, and 288.8 eV, respectively in both Comparative Example 1 and Example 2. At this time, in Example 2, it was found that the intensity of a C—C(C═C) bond peak in the binding energy of 284.6 eV was stronger than Comparative Example 1. The C—C(C═C) bond peak is an indicator showing carbon of a sp² covalent bond and was found to be consistent with the XRD pattern and the Raman spectrum results described above.

In addition, in the high resolution XPS spectrum of N 1 s peaks of (c) and (f) of FIG. 5, it was found that both Comparative Example 1 and Example 2 were formed of a deconvoluted chemical state with pyridinic-N having an N 1s peak at a binding energy of 398.5 eV, pyrrolic-N having an N 1 s peak at a binding energy of 400.0 eV and graphitic-N having an N 1 s peak at a binding energy of 401.0 eV.

The percentages of the pyridinic nitrogen, the pyrrolic nitrogen, and the graphitic nitrogen included in each carbon structure based on the total content (at %) of nitrogen included in Comparative Example 1 and Example 2 are summarized in the following Table 2.

TABLE 2

| | Total N-doping | Pyridinic-N | Pyrrolic-N | Graphitic-N |
|---|---|---|---|---|
| Sample | (at %) | (%) | (%) | (%) |
| Comparative | 9.15 | 60 | 29 | 11 |
| Example 1 | | | | |
| (NPC-750) | | | | |
| Example 2 | 6.73 | 44 | 53 | 3 |
| (HGNPC-750) | | | | |

As shown in Table 2, since Example 2 included 90% or more of the pyridinic nitrogen and the pyrrolic nitrogen as a percentage based on the total content (at %) of nitrogen as compared with Comparative Example 1, when the carbon structure of Example 2 was applied as the host material of sulfur, a shuttle phenomenon of lithium polysulfide may be effectively suppressed.

As described above, since the carbon structure prepared by the acid etching process after preparing the intermediate structure using the magnesiothermic reduction from ZIF-8 as a base had excellent pore properties and also a highly graphitic crystal structure, electrical conductivity properties may be significantly improved.

FIG. 6 is a drawing showing and comparing the electrical conductivity properties of Comparative Example 1 and Example 2.

As shown in FIG. 6, since Example 2 had a much higher graphitic crystal structure than Comparative Example 1, it was confirmed that significantly superior electrical conductivity properties were shown.

### Example 5

A composite was prepared by mixing the carbon structure (HGNPC-750) prepared according to Example 2: pristine sulfur at a weight ratio of 3:7, and then heat treating the mixture at a temperature of 155-300° C. for 12-6 hours (melt diffusion), and was named HGNPC-750-S70.

### Comparative Example 2

A composite was prepared in the same manner as in Example 5 except using the carbon structure (NPC-750) prepared according to Comparative Example 1, and was named NPC-750-S70.

A series of processes of synthesizing composites prepared using the carbon structures of Comparative Example 1 and Example 2 are schematically shown in FIG. 7.

### (Experimental Example 2) Analysis and Comparison of Composite

In FIG. 8, (a) and (b) are drawings showing XRD patterns and thermogravimetric analysis (TGA) results of the composites of Comparative Example 2 and Example 5, respectively. At this time, TGA analysis was performed at a heating rate of 10° C./min under an argon gas atmosphere. Referring to (a) of FIG. 8, in Example 5 (HGNPC-750-S70), the diffraction peak corresponding to sulfur and the amorphous carbon peak were simultaneously observed, but in Comparative Example 2 (NPC-750-S70), only the diffraction peak corresponding to sulfur was observed.

In general, since solid sulfur (S₈) has a molecular size of 0.68 nm at a temperature of 140° C. or lower, there are limits to load sulfur in the pore structure of the carbon structure of Comparative Example 1 formed of micropores as described above, and sulfur included in the composite of Comparative Example 2 is mostly positioned on the surface and only the strong diffraction peak corresponding to sulfur exists. However, in the composite of Example 5, since most sulfur was supported in the carbon structure including mesopores and macropores, diffraction peaks corresponding to sulfur and amorphous carbon, respectively simultaneously existed.

In order to more thoroughly confirm it, upon review of the TGA analysis results of (b) of FIG. 8, it was found that Example 5 had a weight loss occurring at 200 to 420° C., which was a weight loss due to evaporation of sulfur positioned in the pores of the composite.

However, in Comparative Example 2, it was found that a weight loss section was shown in divided two temperature areas of 200 to 320° C. and 320 to 420° C. That is, it was found that a first weight loss occurred in the section of a temperature range of 200 to 320° C. by evaporation of sulfur positioned on the surface of the composite of Comparative Example 2, and a second weight loss occurred in the section of a temperature range of 320 to 420° C. by evaporation of sulfur positioned in the micropores of the composite of Comparative Example 2. It was found therefrom that in Comparative Example 2, about 83% of sulfur was positioned on the surface and about 17% of sulfur was positioned in the micropores, based on the total weight of sulfur included in the composite.

FIGS. 9 and 10 are drawings showing SEM images and X-ray energy dispersive spectroscopy (EDS) element mapping images corresponding to Comparative Example 2 and Example 5, respectively.

As shown in FIGS. 9 and 10, in Comparative Example 2, it was clearly confirmed that a large sulfur residue existed on the surface of the composite, but in Example 5, it was found that sulfur was uniformly distributed in a porous carbon structure matrix and a large sulfur residue was not formed on the surface of the composite. The results were confirmed to be consistent with the XRD pattern and TGA analysis results of the composite described above.

### Example 6

In order to evaluate the electrochemical performance of the composite, a CR2032 coin-type battery was manufactured.

First, the composite of Example 5 was used as the positive electrode active material, and 80 wt % of the positive electrode active material, 10 wt % of a conductive material (acetylene black), and a binder (polyvinylidene fluoride, PVDF) dissolved in N-methyl-2-pyrrolidone (NMP) were stirred for 4 hours to prepare a positive electrode slurry, which was coated on an aluminum foil coated with carbon to manufacture a positive electrode. At this time, a loading amount of sulfur included in the positive electrode was 2 mg/cm².

Subsequently, the manufactured positive electrode, a separator (Celgard 2400), and a negative electrode (lithium metal) were assembled, 1.0 M lithium bis(trifluoromethanesulfonyl)imide (LiTFSI) was dissolved in a mixed solvent (DME/DOL, 1:1 v/v) in which dimethyl ether (DME) and 1,3-dioxolane (DOL) were mixed, and an electrolyte solution to which 0.2 M LiNO₃ was added was injected to manufacture a coin type battery. At this time, 10 μL of an electrolyte solution per 1 mg of sulfur was injected to fix the ratio between the electrolyte solution and sulfur (E/S ratio) to 10 μL/mg.

### Example 7

The process was performed in the same manner as in Example 6, except that the positive electrode was manufactured so that the loading amount of sulfur included in the positive electrode was 4.7 mg/cm².

### Example 8

The process was performed in the same manner as in Example 6, except that the positive electrode was manufactured so that the loading amount of sulfur included in the positive electrode was 8.3 mg/cm².

### Example 9

The process was performed in the same manner as in Example 6, except that the positive electrode was manufactured so that the loading amount of sulfur included in the positive electrode was 10.1 mg/cm².

### Example 10

The process was performed in the same manner as in Example 8, except that the electrolyte solution was injected so that the ratio between the electrolyte solution and sulfur (E/S ratio) was 6.7 μL/mg.

### Example 11

The process was performed in the same manner as in Example 8, except that the electrolyte solution was injected so that the ratio between the electrolyte solution and sulfur (E/S ratio) was 3.8 μL/mg.

### Comparative Example 3

The process was performed in the same manner as in Example 6, except that the composite of Comparative Example 2 was used as the positive electrode active material.

### (Experimental Example 3) Evaluation of Performance of Coin Type Lithium-Sulfur Battery Including Composite

In FIG. 11, (a) and (b) are drawings showing CV profiles measured using cyclic voltammetry (CV) and charge and discharge curves depending on current density measured using galvanostatic charge-discharge for Example 6 (battery including the composite of Example 5 as the positive electrode active material), respectively, and (c) and (d) are drawings showing CV profiles measured using cyclic voltammetry (CV) and charge and discharge curves depending on current density measured using galvanostatic charge-discharge for Comparative Example 3 (battery including the composite of Comparative Example 2 as the positive electrode active material), respectively.

At this time, the cyclic voltammetry was performed in a voltage range of 1.8 to 2.7 V at a scan speed of 0.2 mV/s, and the galvanostatic charge-discharge was performed under current density conditions of 0.2 C, 0.3 C, 0.5 C, 1 C, 2 C, 3 C, and 5 C, respectively.

Referring to (a) and (c) of FIG. 11, in Comparative Example 3, negative electrode peaks (reduction signal) resulting from conversion from solid sulfur (S₈) into lithium polysulfide (Li₂Sₓ, 4<x<8) by a reduction reaction and then conversion into Li₂S₂/Li₂S by a subsequently occurring additional reduction reaction were observed at 2.23 V and 1.92 V, and on the contrary, positive electrode peaks (oxide signal) resulting from subsequent oxidation from Li₂S₂/Li₂S to lithium polysulfide and solid sulfur were observed at 2.44 V and 2.52 V.

However, in Example 6, it was observed that the reduction signal was shown at a higher voltage (2.32 V and 1.99 V), and the oxidation signal was shown at a lower voltage (2.35 V and 2.42 V), and it was confirmed therefrom that the reaction rate of the battery including the composite of Example 5 as the positive electrode active material was significantly superior and the electrochemical reversibility thereof was also excellent.

Additionally, in (b) and (d) of FIG. 11, it was found that in Example 6, distinct charge and discharge plateaus were shown in all charge and discharge curves, and the discharge specific capacity in the charge and discharge current density at 0.2 C, 0.3 C, 0.5 C, 1 C, 2 C, 3 C, and 5 C were 1524 mAh/g, 1408 mAh/g, 1274 mAh/g, 1088 mAh/g, 921 mAh/g, 764 mAh/g, and 703 mAh/g, respectively.

However, in the charge and discharge current density at 0.2 C, 0.3 C, 0.5 C, 1 C, 2 C, 3 C, and 5 C, the discharge specific capacity of Comparative Example 3 was confirmed to be significantly as low as 1272 mAh/g, 1072 mAh/g, 938 mAh/g, 770 mAh/g, 664 mAh/g, 536 mAh/g, and 288 mAh/g. In addition, it was observed that as the current density was increased, a polarization phenomenon was rapidly increased.

It was confirmed therefrom that the electrochemical performance of Example 6 was significantly improved, resulting in fast reaction speed with the excellent electrical conductivity properties of the carbon structure (HGNPC-750) included in the composite of Example 5.

Furthermore, the rate properties of each battery were confirmed by increasing the charge and discharge current density from 0.2 C to 5 C and then changing it to 0.2 C again, and the results are shown in FIG. 12.

As shown in FIG. 12, it was found that the rate property of Example 6 were better than that of the battery of Comparative Example 3, and in particular, when a capacity retention rate was measured by increasing the current density stepwise and then changing it to 0.2 C which was the initial current density again, the capacity retention rate of Example 6 was shown to be about 94% as compared with an initial capacity, but the capacity retention rate of Comparative Example 3 was observed to be significantly reduced to about 78% as compared with the initial capacity.

Subsequently, the cycle properties of the batteries of Example 6 and Comparative Example 3 were compared.

In FIG. 13, (a) and (b) are drawings showing cycle property results for 300 cycles under 0.2 C current density conditions, and a drawing showing cycle property results for 1000 cycles under 5 C current density conditions, respectively.

As shown in (a) and (b) of FIG. 13, it was found that the cycle stability of Example 6 was significantly better than that of the battery of comparative Example 3.

Specifically, Example 6 including the composite of Example 5 as the positive electrode active material was confirmed to have a capacity retention rate of 85% based on the initial capacity after 300 cycles under the current density conditions of 0.2 C, but the battery of Comparative Example 3 including the composite of Comparative Example 2 as the positive electrode active material showed the capacity retention rate property of about 74%.

In addition, it was confirmed that Example 6 had a capacity retention rate property of 82% based on the initial capacity, and Comparative Example 3 had a rapidly reduced capacity retention rate of about 55%, after charge and discharge for 1000 cycles under the current density conditions of 5 C.

As such, the reason for showing excellent cycle stability in Example 6 is that the carbon structure (HGNPC-750) had excellent electrical conductivity properties, and also, the carbon structure included nitrogen containing pyridinic nitrogen and pyrrolic nitrogen at a percentage of 90% or more and the shuttle phenomenon of lithium polysulfide may be effectively suppressed by the morphological properties of the carbon structure.

In order to confirm the resistance inside each battery during the electrochemical reaction, analysis was performed using electrochemical impedance spectroscopy (EIS). EIS measurement was performed with an alternating voltage amplitude of 10 mV in a frequency range of 10 kHz to 100 MHz.

In FIG. 14, (a) and (b) are drawings showing an EIS profile in a completely charged state and an EIS profile measured after charge and discharge of 100 cycles under 0.2 C current density conditions, respectively.

Each resistance (Rₑ, Rᵢₙₜ, and R_{ct}) value calculated by fitting the EIS profiles is summarized in the following Table 3.

Herein, in the EIS profile, an intersection of the x-axis and a Nyquist plot in the high frequency area is Re which is the resistance of an electrolyte solution, a sunken semicircle in the high frequency area is R_{ct} which is a charge transfer resistance in an electrode interface and capacitance (CPE), and Rint is internal resistance.

TABLE 3

| | Before cycling | | | After 100 cycles at 0.2 C | | |
|---|---|---|---|---|---|---|
| | Rₑ | Rᵢₙₜ | R_{ct} | Rₑ | Rᵢₙₜ | R_{ct} |
| Sample | (ohm) | (ohm) | (ohm) | (ohm) | (ohm) | (ohm) |
| Comparative | 5.0 | — | 57.5 | 13.1 | 20.1 | 7.9 |
| Example 3 | | | | | | |
| Example 6 | 4.6 | — | 31.9 | 9.2 | 11.9 | 6.1 |

Referring to Table 3, it was found that Rₑ which is the resistance of the electrolyte solution in the initial battery before the charge and discharge cycle progress was substantially the same, and the charge transfer resistance was significantly low in Example 6.

After 100 cycles of charge and discharge, as shown in (b) of FIG. 14, two sunken semicircles were shown in both batteries, and these corresponded to internal resistance (Rᵢₙₜ) and CPE1 in the high frequency area and the charge transfer resistance (R_{ct}) of the positive electrode and CPE2 in the medium frequency area by forming the insulation layer of Li₂S/Li₂S₂ on the surface of the electrode.

While the charge and discharge cycle progressed, sulfur was redistributed inside the positive electrode, and the charge transfer resistance was rapidly lowered, in particular, was found to be further lowered in the battery of Example 6. This is because in Comparative Example 3, most sulfur was positioned on the surface of the carbon structure due to the properties of the carbon structure (NPC-750) of Comparative Example 1, a shuttle phenomenon in which lithium polysulfide formed during the electrochemical reaction is eluted into an electrolyte solution also and diffuses to a negative electrode occurred. Thus, the electrolyte solution resistance value and the internal resistance value were increased after the charge and discharge of 100 cycles in the battery of Comparative Example 3 including the composite of Comparative Example 2 as the positive electrode active material.

Additionally, each battery (Example 6 and Comparative Example 3) after the charge and discharge test of 200 cycles under the 1 C current density conditions was disassembled and its structural change was analyzed.

In FIG. 15, (a) is a drawing showing digital images of a lithium metal and a separator before battery assembly, a lithium metal and a separator disassembled from the battery of Comparative Example 3, and a lithium metal and a separator disassembled from the battery of Example 6 after a charge and discharge test, and (b), (c) and (d) are drawings showing SEM images of a lithium metal (negative electrode) before battery assembly, a lithium metal disassembled from the battery of Comparative Example 3, and the lithium metal disassembled from the battery of Example 6.

Referring to (a) of FIG. 15, it was observed that the separator disassembled from the battery of Comparative Example 3 including the composite of Comparative Example 2 as the positive electrode active material had a dark yellow stain by lithium polysulfide, and the lithium metal also had a very rough surface as compared with the lithium metal before battery assembly. This is because the lithium polysulfide dissolved in the electrolyte solution passed through the separator and reached the lithium metal as the negative electrode and formed Li₂S and Li₂S₂ on the surface of the negative electrode.

However, it was observed that the separator disassembled from the battery of Example 6 including the composite of Example 5 as the positive electrode active material had a significantly less stain by lithium polysulfide, and the lithium metal also had significantly soft surface properties.

The results may be clearly seen from the SEM images of (b), (c), and (d) of FIG. 15. In Example 6 including the composite of Example 5 as the positive electrode active material, it was found that the shuttle phenomenon of lithium polysulfide formed during the electrochemical reaction was effectively suppressed.

In FIG. 16, (a) and (b) are drawings showing SEM images of a positive electrode slurry including the composite of Comparative Example 2 as a positive electrode active material and a positive electrode slurry including the composite of Example 5 as a positive electrode active material before and after the charge and discharge test of 200 cycles under 1 C current density conditions, respectively.

As shown in (a) and (b) of FIG. 16, in the positive electrode slurry before each charge and discharge test, the composite of Comparative Example 2 had a large amount of sulfur on the surface of the composite and a polyhedron shape was not observed.

However, it was found that the composite of Example 5 had a polyhedron shape resulting from the carbon structure formed of a surface having a concave center. In addition, it was observed that the composite of Example 5 still maintained the polyhedron shape even after the charge and discharge test.

In FIG. 17, (a) and (b) are drawings showing SEM images of cross sections of a positive electrode including the composite of Comparative Example 2 as a positive electrode active material and a positive electrode including the composite of Example 5 as a positive electrode active material before and after the charge and discharge test of 200 cycles under 1 C current density conditions, respectively.

In general, the volume of a positive electrode expands after charge and discharge due to a density difference between sulfur(S) and lithium sulfide (Li₂S). However, since in the positive electrode including the composite of Example 5 as the positive electrode active material, sulfur was encapsulated and positioned in the porous network of the carbon structure including mesopores and macropores, the volume change of the positive electrode may be minimized.

Specifically, referring to (a) and (b) of FIG. 17, it was observed that the thickness of the positive electrode including the composite of Comparative Example 2 as the positive electrode active material was 58.2 μm before the charge and discharge cycle test, but the thickness of the positive electrode was increased to 76.4 μm by 31% after charge and discharge.

However, the positive electrode including the composite of Example 5 as the positive electrode active material had the thickness of the positive electrode after charge and discharge (65.5 μm) which was increased by 9.2% as compared with the thickness before the charge and discharge cycle test (58.2 μm), and the thickness change was found to be effectively suppressed.

Furthermore, the battery properties depending on the loading amount of sulfur and the ratio between the electrolyte solution and sulfur (E/S ratio) were further evaluated.

In FIG. 18, (a) is a drawing showing cycle properties under 0.2 C current density conditions depending on a loading amount of sulfur for a battery to which an electrolyte solution was injected so that a E/S ratio was 10 μL/mg, and (b) is a drawing showing a voltage profile depending on the E/S ratio of a battery having a sulfur loading amount of 8.3 mg/cm².

In (a) of FIG. 18, it was found that as the loading amount of sulfur was increased, the capacity per area was increased. However, in Example 9 in which the loading amount of sulfur was 10.1 mg/cm², it was observed that the cycle stability was lowered.

However, in Example 8 (loading amount of sulfur of 8.3 mg/cm²), the cycle stability was still excellent even after 150 cycles.

In addition, as shown in (b) of FIG. 18, Example 11 having the E/S ratio of 3.8 μL/mg was confirmed to show excellent battery performance even under lean electrolyte conditions.

In order to more thoroughly review the battery performance under the lean electrolyte conditions, the cycle properties, the rate properties, and charge and discharge properties under various current density conditions of Example 11 were measured.

In FIG. 19, (a), (b), and (c) are drawings of cycle properties under 0.2 C current density conditions, rate properties when charge and discharge current densities were increased from 0.2 C to 0.5 C and then changed to 0.2 C again, and charge and discharge curves depending on current densities (0.1 C, 0.2 C, 0.3 C, and 0.5 C) measured using galvanostatic charge-discharge of Example 11, respectively.

As shown in (a) of FIG. 19, the capacity retention rate after 70 cycles was shown to be about 85% even under harsh conditions of a high sulfur loading amount and lean electrolyte, and thus, it was found that the cycle stability was excellent.

As seen in (b) of FIG. 19, since stable electrochemical performance was shown, the rate properties were also found to be excellent.

Furthermore, as shown in the charge and discharge curve of (c) of FIG. 19, still distinct charge and discharge plateaus were shown even under a current density of 0.5 C.

Hereinabove, although the present invention has been described by the specific matters and specific exemplary embodiments, they have been provided only for assisting in the entire understanding of the present invention. Therefore, the present invention is not limited to the exemplary embodiments, and various modifications and changes may be made by those skilled in the art to which the present invention pertains from this description.

Therefore, the spirit of the present disclosure should not be limited to the above-described exemplary embodiments, and the following claims as well as all modifications equal or equivalent to the claims are intended to fall within the scope and spirit of the disclosure.

1. A highly graphitic porous carbon structure which is a polyhedron including at least one surface having a concave center and is doped with nitrogen.

2. The highly graphitic porous carbon structure of claim 1, wherein the type of doped nitrogen includes a pyridinic nitrogen type, a pyrrolic nitrogen type, and a graphitic nitrogen type.

3. The highly graphitic porous carbon structure of claim 2, wherein the doped nitrogen includes 90% or more of the pyridinic nitrogen type and the pyrrolic nitrogen type as a percentage based on the total content (at %) of nitrogen.

4. The highly graphitic porous carbon structure of claim 1, wherein the carbon structure includes micropores, mesopores, and macropores.

5. The highly graphitic porous carbon structure of claim 4, wherein the mesopores are included at 50 vol % or more based on the total volume of the pores included in the carbon structure.

6. The highly graphitic porous carbon structure of claim 1, wherein the carbon structure has a BET surface area of 500 to 1000 m²/g.

7. The highly graphitic porous carbon structure of claim 1, wherein the carbon structure has a ratio (I_{G}/I_{D}) between a G band peak intensity (I_{G}) and a D band peak intensity (I_{D}) of 1 or more in a Raman spectrum.

8. The highly graphitic porous carbon structure of claim 1, wherein the polyhedron has a dodecahedron shape formed of a surface having a concave center.

9. A composite comprising sulfur supported within pores of the highly graphitic porous carbon structure of claim 1.

10. The composite of claim 9, wherein the sulfur is supported at a content of 1 to 15 mg/cm² within the pores of the carbon structure.

11. The composite of claim 9, wherein the sulfur includes one or more selected from the group consisting of inorganic sulfur (S₈), metal sulfides, metal polysulfides, organic sulfur compounds, and polysulfides.

12. The composite of claim 9, wherein the composite has polyhedron shapes including a dodecahedron shape formed of a surface having a concave center.

13. A positive electrode for a lithium-sulfur battery comprising the composite of claim 9 as a positive electrode active material.

14. The positive electrode for a lithium-sulfur battery of claim 13, wherein the positive electrode includes 1 to 15 mg/cm² of sulfur.

15. A lithium-sulfur battery comprising:
a positive electrode including the composite of claim 9 as a positive electrode active material;
a negative electrode including a lithium metal;
a separator disposed between the positive electrode and the negative electrode; and
an electrolyte.

16. The lithium-sulfur battery of claim 15, wherein the positive electrode includes 1 to 15 mg/cm² of sulfur.

17. The lithium-sulfur battery of claim 15, wherein a ratio between the electrolyte and sulfur (E/S ratio) is 2 to 15 μL/mg.

18. A method of preparing a carbon structure, the method comprising:
a) metallothermically reducing a solid mixture in which a metal organic framework including nitrogen and a powdery metal reducing agent are mixed to prepare an intermediate structure; and
b) acid etching a metal and a metal compound included in the intermediate structure to remove them.

19. The method of preparing a carbon structure of claim 18, wherein the metal reducing agent is one or more selected from the group consisting of magnesium (Mg), manganese (Mn), calcium (Ca), aluminum (Al), copper (Cu), zinc (Zn), tin (Sn), gallium (Ga), lithium (Li), sodium (Na), potassium (K).

20. The method of preparing a carbon structure of claim 18, wherein the metal organic framework is ZIF-8.

21. The method of preparing a carbon structure of claim 18, wherein the metallothermic reduction is performed at a temperature of 500 to 1000° C. under an inert gas atmosphere.
